(19) United States
(12) Patent Application Publication
(10) Pub. No.: US 2025/0371827 A1
(43) Pub. Date: Dec. 4, 2025

(54) INFORMATION PROCESSING DEVICE, PROGRAM, AND INFORMATION PROCESSING SYSTEM

(71) Applicant: SONY GROUP CORPORATION, TOKYO (JP)

(72) Inventors: GEN HAMADA, TOKYO (JP); SHINTARO TSUTSUI, TOKYO (JP)

(21) Appl. No.: 18/878,012

(22) PCT Filed: May 11, 2023
(86) PCT No.: PCT/JP2023/017771

§ 371 Date: Dec. 21, 2024

(30) Foreign Application Priority Data
Jun. 29, 2022 (JP) 2022-104376

(51) Int. Cl. G06T 19/20; G06T 13/40

(52) U.S. Cl. CPC G06T 19/20; G06T 13/40; G06T 2219/2004

(57) ABSTRACT

[Problem] A technology is provided capable of reducing the positional misalignment of a user in a virtual space as appropriate according to the situation. [Means of Solution] An information processing device is provided, including a control unit that: sets, as a shared object for a first user and a second user, a virtual object located within a first range whose base point is the first user in a virtual space, with the second user being present within a second range whose base point is the virtual object; transmits relative information indicating a relative positional relationship between the shared object and the first user to a user terminal associated with the second user; and switches the setting of the shared object in response to a change in at least any of a position of the first user, a position of the shared object, and a position of the second user in the virtual space.

### TECHNICAL FIELD

The present disclosure relates to an information processing device, a program, and an information processing system.

### BACKGROUND ART

In recent years, technologies that enable users to communicate with each other while sharing virtual objects in a virtual space, such as virtual reality (VR), augmented reality (AR), and mixed reality (MR), have been considered.

In such technologies, data such as the position, posture, or voice of each user is transmitted to other users who share the virtual space. On the receiving side, based on the received data, a virtual object representing the user who transmitted the data is drawn at a specified position in the virtual space. Such drawing processing being performed on both the transmitting and receiving sides achieves communication between the users in the virtual space.

For example, PTL 1 listed below discloses a technology for determining, based on a relative positional relationship between each user and a specific virtual object, a display position of a virtual object shared by the users.

### CITATION LIST

### Patent Literature

[PTL 1]

U.S. Patent Application Publication No. 2014/368534 (Specification)

### SUMMARY

### Technical Problem

However, when the virtual objects representing the respective users are displayed in the virtual space, the position of each user drawn in the virtual space may be misaligned due to differences in the environment in which the position, posture, or the like of each user is measured, resulting in a significant lack of realism. In the technology disclosed in PTL 1, only the positional relationship between the specific virtual object and each user is used to determine the display position, and positional misalignment of users with respect to objects other than the specific virtual object may occur.

Therefore, the present disclosure provides a technology capable of reducing the positional misalignment of a user in a virtual space as appropriate according to the situation.

### Solution to Problem

In order to solve the above problem, according to an aspect of the present disclosure, an information processing device is provided, including a control unit that: sets, as a shared object for a first user and a second user, a virtual object located within a first range whose base point is the first user in a virtual space, with the second user being present within a second range whose base point is the virtual object;

transmits relative information indicating a relative positional relationship between the shared object and the first user to a user terminal associated with the second user; and switches the setting of the shared object in response to a change in at least any of a position of the first user, a position of the shared object, and a position of the second user in the virtual space.

According to the present disclosure, a program is provided for causing a computer to function as a control unit that: sets, as a shared object for a first user and a second user, a virtual object located within a first range whose base point is the first user in a virtual space, with the second user being present within a second range whose base point is the virtual object; transmits relative information indicating a relative positional relationship between the shared object and the first user to a user terminal associated with the second user; and switches setting of the shared object in response to a change in at least any of a position of the first user, a position of a virtual object set as the shared object, and a position of the second user in the virtual space.

According to the present disclosure, an information processing system is provided, including: a first user terminal associated with a first user; a second user terminal associated with a second user; and an information processing device including a control unit that: sets, as a shared object for the first user and the second user, a virtual object located within a first range whose base point is the first user in a virtual space, with the second user being present within a second range whose base point is the virtual object; transmits relative information indicating a relative positional relationship between the shared object and the first user to the second user terminal; and switches setting of the shared object in response to a change in at least any of a position of the first user, a position of a virtual object set as the shared object, and a position of the second user in the virtual space, wherein the second user terminal displays a user object representing the first user at a position in a virtual space calculated based on the relative information received from the information processing device.

### BRIEF DESCRIPTION OF DRAWING

FIG. 1 is an explanatory diagram illustrating an overview and a functional configuration example of an information processing system according to the present disclosure.

FIG. 2 is an explanatory diagram illustrating a positional misalignment of a user avatar displayed in a virtual space.

FIG. 3 is a block diagram illustrating in more detail the functions of a control unit 220 of a user terminal 20.

FIG. 4 is an explanatory diagram illustrating an example of a shared object setting unit 225 setting and canceling a shared object.

FIG. 5 is an explanatory diagram illustrating another example of the shared object setting unit 225 setting and canceling a shared object.

FIG. 6 is an explanatory diagram illustrating another example of the shared object setting unit 225 setting and canceling a shared object.

FIG. 7 is an explanatory diagram illustrating an example of the shared object setting unit 225 switching the shared object.

FIG. 8 is an explanatory diagram illustrating another example of the shared object setting unit 225 switching the shared object.

FIG. 9 is an explanatory diagram illustrating another example of the shared object setting unit 225 switching the shared object.

FIG. 10 is an explanatory diagram illustrating another example of the shared object setting unit 225 switching the shared object.

FIG. 11 is an explanatory diagram illustrating an example of the shared object setting unit 225 setting a shared object for each of different other users.

FIG. 12 is an explanatory diagram illustrating another example of the shared object setting unit 225 setting a shared object for each of different other users.

FIG. 13 is a sequence diagram illustrating an example of an operation of an information processing system according to an embodiment of the present disclosure.

FIG. 14 is a first flowchart illustrating an operation flow of position information acquisition processing by a user terminal 20.

FIG. 15 is a second flowchart illustrating an operation flow of the position information acquisition processing by the user terminal 20.

FIG. 16 is a flowchart illustrating an example of an operation of processing of the user terminal 20 displaying avatars based on received position information.

FIG. 17 is a sequence diagram illustrating an example of operation processing of the information processing system when a server 10 performs position information acquisition processing, shared object setting processing, and display control processing.

FIG. 18 is a sequence diagram illustrating an example of operation processing of the information processing system when user terminals 20 communicate directly with each other.

FIG. 19 is a block diagram illustrating an example of a hardware configuration 90.

### DESCRIPTION OF EMBODIMENTS

Preferred embodiments of the present disclosure will be described in detail with reference to the accompanying figures below. Also, in the present specification and the figures, components having substantially the same functional configuration will be denoted by the same reference numerals, and thus repeated descriptions thereof will be omitted.

In the present specification and drawings, a plurality of components having substantially the same functional configuration may be distinguished by different numerals added after the same reference signs. However, when it is not necessary to particularly distinguish each of a plurality of components having substantially the same functional configuration, each of the plurality of components is simply denoted with the same reference sign.

The description will be given in the following order.
1. Overview of Information Processing System according to One Embodiment of Present Disclosure
2. Functional Configuration Example
2-1. Server 10
2-2. User Terminal 20
3. Operation Example
4. Modification Example
5. Hardware Configuration Example
6. Supplements

### 1. Overview of Information Processing System according to One Embodiment of Present Disclosure

The present disclosure relates to a technology capable of reducing positional misalignment of a user in a virtual space as appropriate according to the situation.

An application suitable for the present disclosure is a technology that uses VR or AR technology to display to a user a two-dimensional or three-dimensional virtual space constructed in a computer or on a computer network. With such technology, an avatar of each user, which allows the user to operate it, is displayed in a virtual space, so that users can operate their avatars to communicate with each other. Such a virtual space is sometimes referred to as the metaverse.

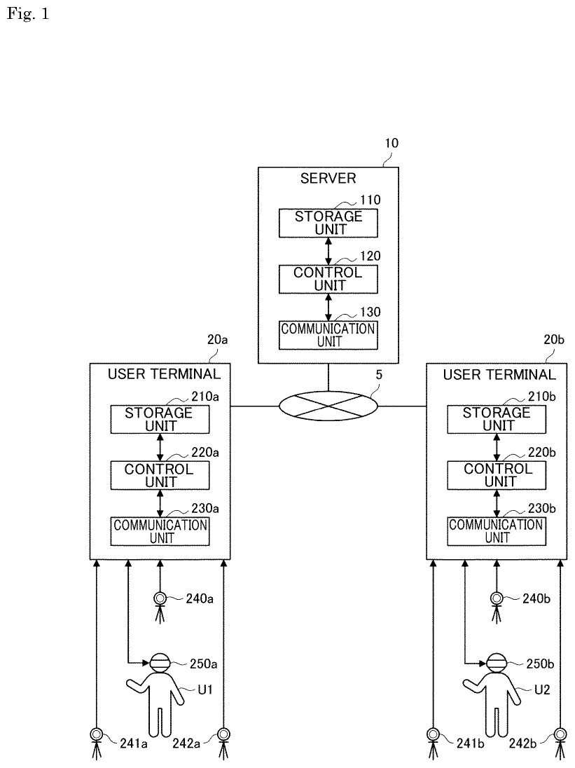

FIG. 1 is an explanatory diagram illustrating an overview and a functional configuration example of an information processing system according to the present disclosure. As illustrated in FIG. 1, the information processing system according to the present disclosure includes a server 10 and a user terminal 20. The server 10 and the user terminal 20 are configured to be able to communicate with each other via a network 5.

The user terminal 20 is a client terminal that senses the position or posture of a user U in a real space and acquires, based on the sensing data, position information that indicates the position and posture of the user U in a virtual space. The user terminal 20 receives position information of other users U in the virtual space from the server 10 and performs, based on the received position information, display control processing on virtual objects that represent other users U (hereinafter also referred to as user objects or avatars). The user terminal 20 is realized by an information processing terminal such as a personal computer or a smartphone. The information processing system according to the present disclosure includes a plurality of user terminals 20. In FIG. 1, as an example, two user terminals 20 are illustrated: a user terminal 20a used by a user U1 and a user terminal 20b used by a user U2. However, the present disclosure is not limited to this example, and the information processing system may include three or more user terminals 20.

As illustrated in FIG. 1, the user terminal 20 is connected to an HMD 250, which is a head mounted display (HMD) that can be worn on the head of the user U, a camera 240, a camera 241, and a camera 242. The user terminal 20 acquires, based on sensing data acquired by the HMD 250, the camera 240, the camera 241, and the camera 242, position information that indicates the position and posture of the user U in the virtual space. The acquired sensing data includes, for example, the angular velocity and acceleration of the head of the user U wearing the HMD 250, a first-person perspective moving image of the user U, and a moving image of the user U. The user terminal 20 transmits the acquired position information of the user U to the server 10.

The HMD 250 is an example of a display device that displays a virtual space according to the control of the control unit 220. The display device may be, in place of or in addition to the HMD, a CRT display device, a liquid crystal display (LCD), or an OLED device, or may be a TV device, a projector, a smartphone, a tablet terminal, a personal computer (PC), or the like.

The HMD 250 is realized by an optically transmissive display that implements AR technology or MR technology that allows virtual objects, which are information on a virtual space, to be superimposed on a real space while the real space is directly visible to the user's eyes. In this case, the HMD 250 may be a glasses-type terminal or a goggles-type terminal. The HMD 250 may be realized by a non-transmissive display that covers the user's field of view with a display unit. In this case, the user terminal 20 may display virtual objects to the user U via the HMD 250 using VR technology that allows the user to view a virtual space in which 3D models and others are placed from any viewpoint.

The number of cameras connected to the respective user terminals 20 is not limited to three, and the number of cameras can be set appropriately according to the number required to acquire the position information of the users U. The camera 240, the camera 241, and the camera 242 are examples of sensors for acquiring the position, posture, and the like of the user U. Each sensor may be, for example, a visible light camera, an infrared camera, or a depth camera, or may be an event-based camera that outputs only the parts of a subject where their luminance values have changed. The sensor may be a distance sensor, an ultrasonic sensor, or the like.

The server 10 is an information processing device that has a function as a relay server and a function of transmitting the position information of each user received from the corresponding user terminal 20 to other user terminals 20. When each of the user terminals 20 receives the position information of the other users U from the server 10, the user terminal 20 displays user objects representing the other users in the virtual space based on the position information. The user objects may be live-action avatars generated based on live pictures of the users, or may be fictitious virtual object images such as characters. In the following description and drawings, for convenience of explanation, a virtual object may be referred to as a virtual body.

### Organization of Problems

As described above, when users are displayed in the virtual space, the position of each user drawn in the virtual space may be misaligned due to differences in the environment in which the position, posture, or the like of each user is measured. When the distance between a user and a virtual object is sufficient, a misalignment in display position between the virtual object and the user is unlikely to be noticed by the user. However, when users are positioned sufficiently close to a virtual object, a misalignment of the display position of a user will create increased discomfort. In particular, when a common virtual object is present in a position that allows users to view each other in the virtual space, the positional relationship between the virtual object and each user is highly noticeable. For example, in communication between users in the metaverse, they may make conversations or discussions while sharing virtual objects. For example, there is a possible use case in which a virtual object of a product under development is shared among a plurality of users and communication is carried out regarding the virtual object. There is also another possible use case in which a plurality of users sit next to each other in a vehicle represented by a virtual object to drive around. In this case, a positional misalignment between the virtual object and each user creates discomfort and impediments to communication.

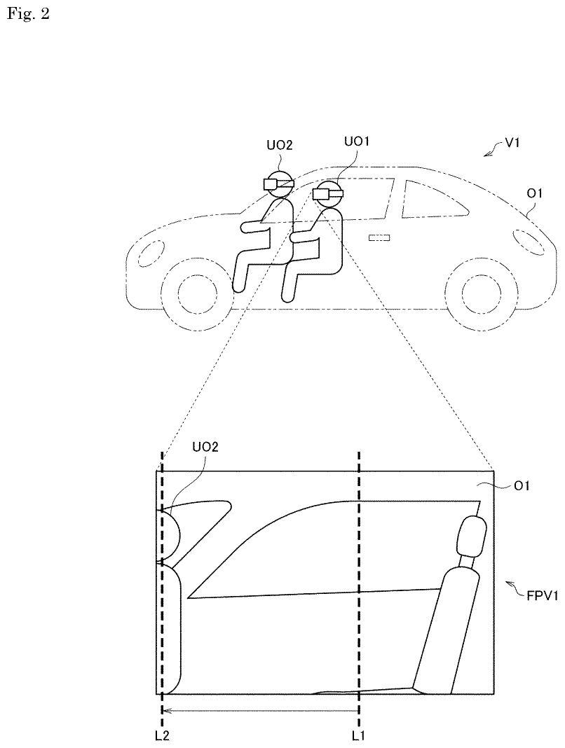

FIG. 2 is an explanatory diagram illustrating a positional misalignment of a user avatar displayed in a virtual space. The virtual space V1 illustrated in the upper part of FIG. 2 includes a virtual object O1 representing a passenger vehicle, a user object UO1, and a user object UO2. In the virtual space V1, two users, the user object UO1 and the user object UO2, are present inside the virtual object O1 representing the passenger vehicle. The user object UO1 is a user object corresponding to the user U1 illustrated in FIG. 1. Similarly, the user object UO2 is a user object corresponding to the user U2.

In the virtual space V1, the user object UO1 is displayed at the position of the front left seat in the virtual object O1. On the other hand, the user object UO2, which should be displayed at the position of the front right seat in the virtual object O1, is displayed at a position shifted forward of the correct position of the seat and buried in the dashboard. Such a misalignment of the display position can occur due to factors such as the distance measurement accuracy of the sensors (e.g., cameras) used to acquire the position information of the users U1 and U2, the difference in performance between the HMDs worn by the users, the difference in installation position between the sensors, or the difference in calibration accuracy, for example.

A first-person perspective image FPV1 illustrated in the lower part of FIG. 2 is an image when viewed toward the front right seat inside the virtual object O1 from the position of the user object UO1 illustrated in the virtual space V1 in the upper part, that is, a first-person perspective image of the user U1 in the virtual space. As illustrated in the first-person perspective image FPV1, when viewed by the user U1, the user object UO2 is displayed shifted from its original ideal display position (the position of the front right seat inside the vehicle) indicated by a dotted line L1 to a position indicated by a dotted line L2 in front of the passenger vehicle (the virtual object O1). The user object UO2 may be out of the field of view of the user U1, or the user object UO2 may be buried in the dashboard on the front side of the virtual object O1, or may be displayed outside the virtual object O1. Such a positional misalignment of the display position of the user object reduces the sense of realism in the virtual space, creating discomfort and impediments to communication.

In order to eliminate such a positional misalignment, for example, PTL 1 discloses using a relative positional relationship between a specific virtual object and each user, but when there are a plurality of virtual objects, this is not effective for objects other than the specific virtual object. For example, in the example described with reference to FIG. 2, if the virtual object O1 representing the passenger vehicle is not the specific virtual object, there is a possibility that the misalignment of the display position of the user object UO2 will not be eliminated.

Therefore, in one embodiment of the present disclosure, it is possible to reduce the positional misalignment of a user in a virtual space as appropriate according to the situation. More specifically, according to an embodiment of the present disclosure, the positional misalignment is reduced by using, as a display position of each user in a virtual space, relative information indicating a relative positional relationship between a virtual object and each user in the virtual space. Here, by appropriately switching the virtual object that serves as a base point for the relative positional relationship with each user to one virtual object that satisfies a predetermined condition among a plurality of virtual objects in the virtual space, it is possible to reduce the positional misalignment of the users as appropriate according to the situation. Such an embodiment of the present disclosure will be described below in detail.

### 2. Functional Configuration Example

### 2-1. Server 10

First, referring again to FIG. 1, a functional configuration example of the server 10 according to the present embodiment will be described. As illustrated in FIG. 1, the server 10 includes a storage unit 110, a control unit 120, and a communication unit 130.

### Storage Unit 110

The storage unit 110 is a storage device capable of storing programs and data for operating the control unit 120. The storage unit 110 can also temporarily store various types of data required during the operation of the control unit 120. For example, the storage device may be a non-volatile storage device.

### Control Unit 120

The control unit 120 has a function of controlling the overall operation of the server 10. The control unit 120 includes a central processing unit (CPU) and others, and its functions can be implemented by the CPU loading a program stored in the storage unit 110 into a random access memory (RAM) and executing it. In this case, a computer-readable recording medium having the program recorded therein may also be provided. Alternatively, the control unit 120 may be configured with dedicated hardware, or may be configured with a combination of a plurality of pieces of hardware. The control unit 120 thus configured controls the communication unit 130, which will be described later, to transmit the position information of a user U received from a user terminal 20 to the other user terminals 20. In the example illustrated in FIG. 1, the control unit 120 causes the communication unit 130 to transmit the position information of the user U1 received from the user terminal 20a to the user terminal 20b. Furthermore, the control unit 120 causes the communication unit 130 to transmit the position information of the user U2 received from the user terminal 20b to the user terminal 20a.

### Communication Unit 130

The communication unit 130 communicates with the user terminal 20 via the network 5 under the control of the control unit 120. For example, the communication unit 130 transmits the position information of each user U received from the corresponding user terminal 20 to the other user terminals 20 under the control of the control unit 120.

### 2-2. User Terminal 20

Next, a functional configuration example of the user terminal 20 according to the present embodiment will be described. As illustrated in FIG. 1, the user terminal 20 includes a storage unit 210, a control unit 220, and a communication unit 230. The user terminal 20 is communicatively connected to the camera 240, the camera 241, the camera 242, and the HMD 250. It may be configured to be able to communicate with the user terminal 20, the camera 240, the camera 241, the camera 242, and the HMD 250 via a wired connection, or may be configured to be able to communicate with them through wireless communication.

### Storage Unit 210

The storage unit 210 is a storage device capable of storing programs and data for operating the control unit 220. The storage unit 210 can also temporarily store various types of data required during the operation of the control unit 220. For example, the storage device may be a non-volatile storage device.

### Control Unit 220

The control unit 220 has a function of controlling the overall operation of the user terminal 20. The control unit 220 includes a central processing unit (CPU) and others, and its functions can be implemented by the CPU loading a program stored in the storage unit 210 into a random access memory (RAM) and executing it. In this case, a computer-readable recording medium having the program recorded therein may also be provided. Alternatively, the control unit 220 may be configured with dedicated hardware, or may be configured with a combination of a plurality of pieces of hardware.

The control unit 220 thus configured acquires position information indicating the position and posture of the user U in the virtual space based on sensing data of the user U. The control unit 220 controls the communication unit 230 to transmit the acquired position information of the user U to the server 10. Here, the control unit 220 has a function of appropriately generating position information to be transmitted to the server 10 according to the situation of the positional relationship between the user U, other users, and virtual objects in the virtual space, as described below.

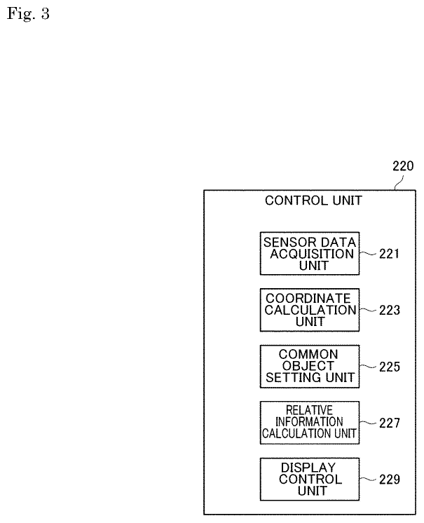

More specifically, the control unit 220 may use, as the position information of the user U, the coordinates of an absolute position in the virtual space, or may use a relative positional relationship with a specific virtual object, may use relative information indicating a relative positional relationship with a virtual object set as a shared object with other users U. The shared object is a virtual object, in the virtual space, which serves as a base point for calculating the relative information, and a virtual object that satisfies a predetermined condition regarding the positions of the user U and the other users U is set as the shared object by the control unit 220. The control unit 220 can appropriately switch the virtual object set as the shared object in response to a change in the situation, such as when the user U moves. This makes it possible for the user terminal 20 that receives the position information to reduce the misalignment of the display position of the user object UO representing the user U. The details of processing of the control unit 220 thus configured acquiring the position information of the user U and setting the shared object will be described in more detail later with reference to FIGS. 3 to 12.

### Communication Unit 230

The communication unit 230 has a function of communicating with the server 10 under the control of the control unit 220. For example, the communication unit 230 transmits the position information of the user U to the server 10 under the control of the control unit 220. The communication unit 230 also receives the position information of each of the other users U from the server 10.

The functional configuration example of the user terminal 20 has been described above with reference to FIG. 1. Subsequently, the processing of the control unit 220 of the user terminal 20 acquiring the position information of the user U and setting the shared object will be described in more detail with reference to FIGS. 3 to 12.

FIG. 3 is a block diagram illustrating in more detail the functions of the control unit 220 of the user terminal 20. The control unit 220 described above has functions as a sensor data acquisition unit 221, a coordinate calculation unit 223, a shared object setting unit 225, a relative information calculation unit 227, and a display control unit 229, as illustrated in FIG. 3.

The sensor data acquisition unit 221 has a function of acquiring sensing data from the camera 240, the camera 241, the camera 242, and the HMD 250. For example, the sensor data acquisition unit 221 acquires moving images of the user U from the camera 240, the camera 241, and the camera 242 for use in calculating the position information. The sensor data acquisition unit 221 also acquires, from the HMD 250, data such as the user U's voice, and angular velocity or acceleration indicating the posture and orientation of the user U's head. The three cameras are used herein as an example of sensors for acquiring sensing data of the user U, but as described above, each camera is an example of a sensor. The sensor may be, for example, a visible light camera or an infrared camera, or may be an event-based camera that outputs only the parts of a subject where their luminance values have changed.

The coordinate calculation unit 223 has a function of calculating the position of the user U in the virtual space based on the sensing data acquired by the sensor data acquisition unit 221. For example, the coordinate calculation unit 223 analyzes the moving images of the user U acquired from the camera 240, the camera 241, and the camera 242 to observe the movement of the user U in the real space, and estimates the position and posture of the user U in the real space. Specifically, the coordinate calculation unit 223 can estimate 3D coordinates from 2D coordinates calculated from a large number of moving images. At this time, the coordinate calculation unit 223 may calculate 3D coordinates indicating the positions of parts of the user U's body in association with the center position of the user U's body. The algorithm for the method of calculating the position coordinates of the user U is not particularly limited. Moving images are used herein as an example, but the data is not limited thereto, and sensing data from various types of sensors attached to the user U may be used. Then, based on the above-described estimation result of the position and posture of the user U, the coordinate calculation unit 223 calculates the coordinates of the absolute position of the user U in the virtual space, or the relative positional relationship between the user U and the specific virtual object serving as a preset reference. The coordinate calculation unit 223 may calculate the position of the user U in the virtual space according to operation input information (movement instruction) by the user, not limited to the sensing data obtained by sensing the user.

The shared object setting unit 225 has a function of setting a shared object to be shared among the user U and other users U. More specifically, the shared object setting unit 225 identifies a virtual object that is located within a predetermined range (hereinafter, a first range) whose base point is the position of the user U1 in the virtual space calculated by the coordinate calculation unit 223, another user being located within a predetermined range (hereinafter, a second range) whose base point is the virtual object, and sets the virtual object as a shared object for the user U and the other user U.

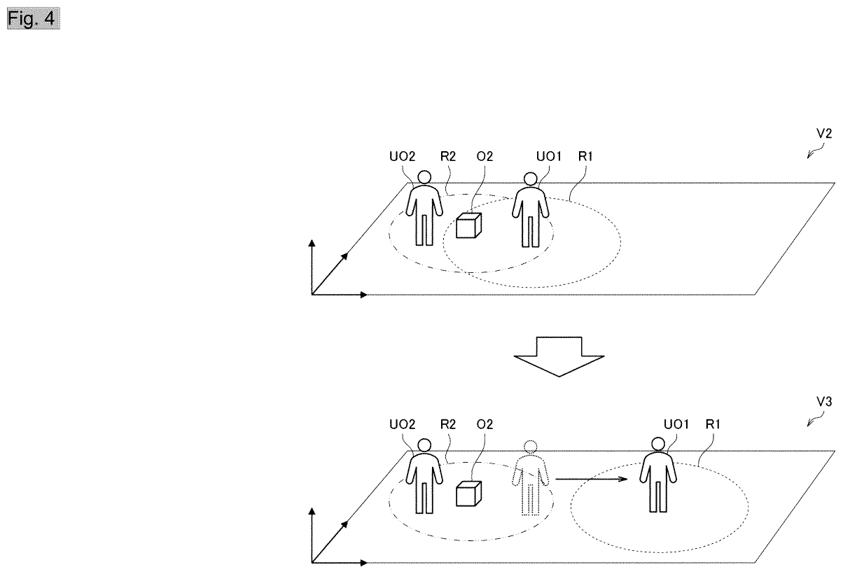

The shared object setting unit 225 also has a function of canceling the setting of the virtual object that has been set as a shared object. Furthermore, the shared object setting unit 225 has a function of switching the shared object by canceling the setting of the shared object and then setting a new different virtual object as the shared object. The processing of the shared object setting unit 225 setting, canceling, and switching the shared object will now be described in more detail with reference to FIGS. 4 to 12. In the following description, an example will be described in which position information of the user U1 in the virtual space is acquired by the function of the shared object setting unit 225 included in a control unit 220a of the user terminal 20a illustrated in FIG. 1.

### Example 1 of Setting and Canceling Shared Object

FIG. 4 is an explanatory diagram illustrating an example of the shared object setting unit 225 setting and canceling a shared object. A virtual space V2 illustrated in the upper part of FIG. 4 includes a user object UO1, a user object UO2, and a virtual object O2. A virtual space V3 illustrated in the lower part of FIG. 4 is a virtual space in a state where the positional relationship between the user object UO1, the user object UO2, and the virtual object O2 has changed from the state of the virtual space V2 due to the movement of the user object UO1.

In the virtual space V2, the virtual object O2 is located between the user object UO1 and the user object UO2. In the processing of setting a shared object, the shared object setting unit 225 of the user terminal 20 first identifies virtual objects located within a first range whose base point is the user object UO1. In the virtual space V2 illustrated in FIG. 4, the virtual object O2 located within a first range R1 is identified. Next, the shared object setting unit 225 of the user terminal 20 sets, as a shared object, a virtual object among the virtual objects located within the identified first range R1, another user other than the user object UO1 being present within a second range whose base point is the virtual object. In the virtual space V2, since the user object UO2 is present within a second range R2 whose base point is the virtual object O2, the shared object setting unit 225 sets the virtual object O2 as a shared object for the user objects UO1 and UO2.

When the shared object is set by the shared object setting unit 225, the relative information calculation unit 227 of the user terminal 20 calculates relative information indicating the relative positional relationship between the shared object and the user object UO1. The relative information also includes identification information of the virtual object set as the shared object. Next, the communication unit 230 transmits the calculated relative information as the position information of the user U to the server 10 under the control of the control unit 220.

Next, assume that the state of the virtual space V2 is transitioned to the state of the virtual space V3. As illustrated in FIG. 4, in the virtual space V3, the user object UO1 is moving in a direction away from the user object UO2 and the virtual object O2. Furthermore, due to the movement of the user object UO1, the virtual object O2 is located outside the first range R1. In this case, since the virtual object located within the first range R1 whose base point is the user object UO1 is no longer detected, the shared object setting unit 225 cancels the setting of the shared object for the virtual object O2.

When the shared object setting unit 225 cancels the setting of the shared object and no other virtual object is set as a shared object, the control unit 220 of the user terminal 20 sets, as the position information of the user U to be transmitted to the server 10, the coordinates of the absolute position of the user U in the virtual space calculated by the coordinate calculation unit 223, or the relative position with respect to the specific virtual object. The communication unit 230 transmits the above-described position information to the server 10 under the control of the control unit 220.

An example of the shared object setting unit 225 setting and canceling a shared object has been described above. Thus, in the information processing system according to the present disclosure, as position information of each user U in the virtual space, a relative position with respect to a virtual object (shared object) to be shared with another user U is transmitted. At this time, a virtual object within a first range, which is a predetermined range whose base point is the user U, may be set as the shared object. Accordingly, only the virtual object that is relatively close to the user U, rather than a virtual object that is too far away from the user U, is used as a base point for the relative position with respect to the user U, so that the misalignment of the display position of the user U can be more effectively reduced.

Furthermore, in the information processing system according to the present disclosure, only when another user U is present within a second range whose base point is the virtual object, that virtual object among virtual objects located within the first range is set as the shared object for the user U and the other user U. As a result, only when another user U is present relatively close to the target virtual object, the position information of the user U to be transmitted to the other user U becomes the relative information. When any other user U is not present within the second range, the coordinates of the absolute position of the user U or the relative position with respect to the specific virtual object is transmitted to the other user U as the position information. Therefore, when viewed from the perspective of the other user U, the user object representing the user U is displayed based on the relative position of the user U with respect to the virtual object that is closer to the other user U, thereby more effectively reducing the misalignment of the display position of the user U.

### Example 2 of Setting and Canceling Shared Object

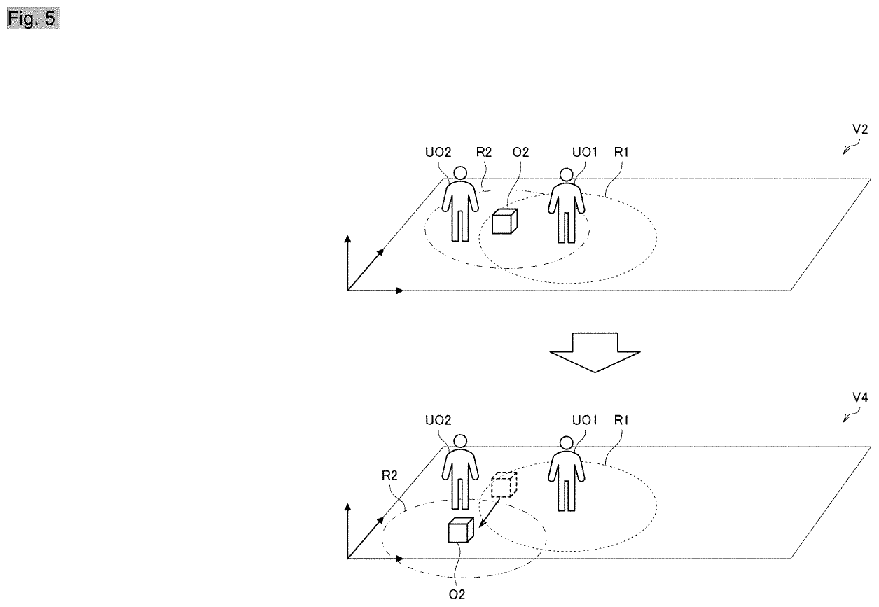

Subsequently, another example of the shared object setting unit 225 setting and canceling a shared object will be described with reference to FIG. 5. FIG. 5 is an explanatory diagram illustrating another example of the shared object setting unit 225 setting and canceling a shared object. The virtual space V2 illustrated in the upper part of FIG. 5 is as described with reference to FIG. 4, and thus description thereof is omitted here. A virtual space V4 illustrated in the lower part of FIG. 5 is a virtual space in a state where the positional relationship between the user object UO1, the user object UO2, and the virtual object O2 has changed from the state of the virtual space V2 due to the movement of the position of the virtual object O2.

As described with reference to FIG. 4, in the state of the virtual space V2, the shared object setting unit 225 sets the virtual object O2 as a shared object for the user object UO1 and the user object UO2.

Next, assume that the state transitions from the virtual space V2 to the virtual space V4. As illustrated in FIG. 5, in the virtual space V4, the position of the virtual object O2 has changed from a position within the first range R1 to a position outside the first range R1. In this case, since any virtual object located within the first range R1 whose base point is the user object UO1 is no longer detected, the shared object setting unit 225 cancels the setting of the shared object for the virtual object O2.

Another example of the shared object setting unit 225 setting and canceling a shared object has been described above.

### Example 3 of Setting and Canceling Shared Object

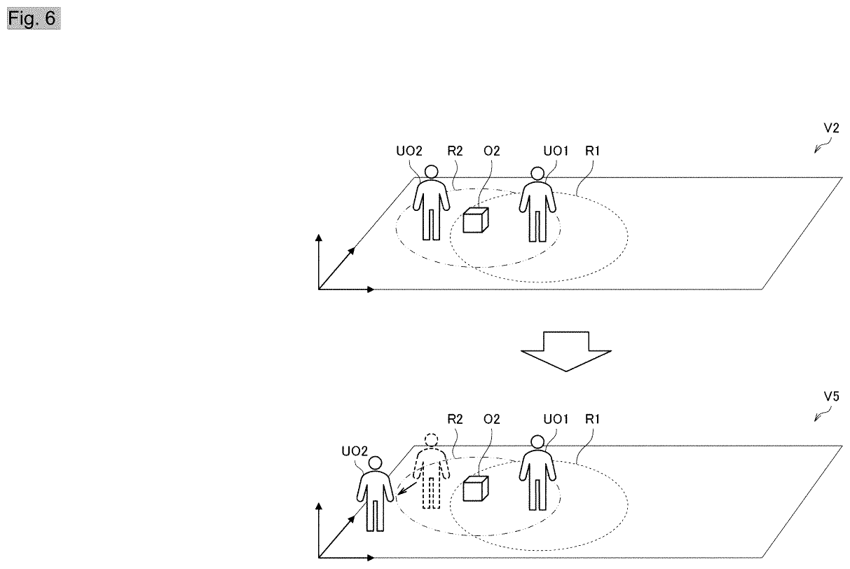

Subsequently, another example of the shared object setting unit 225 setting and canceling a shared object will be described with reference to FIG. 6. FIG. 6 is an explanatory diagram illustrating another example of the shared object setting unit 225 setting and canceling a shared object. The virtual space V2 illustrated in the upper part of FIG. 6 is as described with reference to FIG. 4, and thus description thereof is omitted here. A virtual space V5 illustrated in the lower part of FIG. 6 is a virtual space in a state where the positional relationship between the user object UO1, the user object UO2, and the virtual object O2 has changed from the state of the virtual space V2 due to the movement of the position of the user object UO2.

As described with reference to FIG. 4, in the state of the virtual space V2, the shared object setting unit 225 sets the virtual object O2 as a shared object for the user object UO1 and the user object UO2.

Next, assume that the state transitions from the virtual space V2 to the virtual space V5. As illustrated in FIG. 6, in the virtual space V5, the position of the user object UO2 has changed to a position outside the second range R2. In this case, since any other user located within the second range R2 whose base point is the virtual object O2 is no longer detected, the shared object setting unit 225 cancels the setting of the shared object for the virtual object O2.

Another example of the shared object setting unit 225 setting and canceling a shared object has been described above.

### Example 1 of Setting and Switching Shared Object

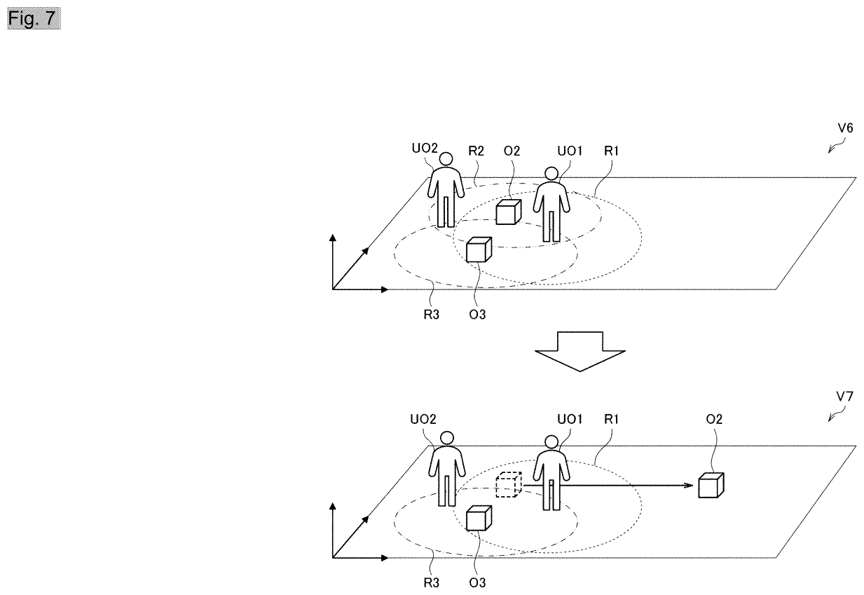

Subsequently, the processing of the shared object setting unit 225 switching the shared object will be described in detail with reference to FIGS. 7 to 10. After setting a shared object for a certain virtual object, the shared object setting unit 225 cancels the setting of the shared object for the virtual object and sets a new virtual object as the shared object, thereby switching the setting of the shared object. Canceling of the shared object and setting of a new shared object may be performed sequentially or simultaneously. When there are a plurality of virtual objects that can each be set as a shared object within the first range whose base point is the user U, the shared object setting unit 225 selects one virtual object and sets it as the shared object. At this time, the shared object setting unit 225 may select one virtual object that is closest to the user U from among the plurality of virtual objects.

FIG. 7 is an explanatory diagram illustrating an example of the shared object setting unit 225 switching the shared object. In the example illustrated in FIG. 7, the setting of a shared object by the shared object setting unit 225 will be described in a case where a plurality of virtual objects are located within a first range R1 whose base point is a user object UO1.

A virtual space V6 illustrated in the upper part of FIG. 7 indicates a virtual space including the user object UO1, a user object UO2, a virtual object O2, and a virtual object O3. A virtual space V7 illustrated in the lower part of FIG. 7 is a virtual space in a state where the positional relationship between the user object UO1, the user object UO2, the virtual object O2, and the virtual object O3 has changed from the state of the virtual space V6 due to the movement of the position of the virtual object O2. In the virtual space V6, the virtual object O2 is located closer to the user object UO1 than to the virtual object O3.

As illustrated in FIG. 7, in the virtual space V6, the plurality of virtual objects, which includes the virtual object O2 and the virtual object O3, are located within the first range R1 whose base point is the user object UO1. The user object UO2 is present within a second range R2 whose base point is the virtual object O2. The user object UO2 is also present within a second range R3 whose base point is the virtual object O3.

In the state of the virtual space V6, the shared object setting unit 225 of the user terminal 20 first identifies virtual objects located within the first range whose base point is the user object UO1. In the example of the virtual space V6 illustrated in FIG. 7, a plurality of virtual objects, that is, the virtual object O2 and the virtual object O3, are identified. When a plurality of virtual objects are located within the first range R1 whose base point is the user object UO1, and another user is present within any of the second ranges whose base point is the respective virtual objects, the shared object setting unit 225 selects one virtual object from among the plurality of virtual objects and sets it as the shared object. At this time, the shared object setting unit 225 may select the virtual object that is closest to the user object UO1 from among the plurality of virtual objects. In the example illustrated in the virtual space V6 in FIG. 7, the shared object setting unit 225 sets, as the shared object, the virtual object O2, which is a virtual object closest to the user object UO1, among the virtual objects O2 and O3.

Next, assume that the state transitions from the virtual space V6 to the virtual space V7. As illustrated in FIG. 7, in the virtual space V7, the position of the virtual object O2 has moved outside the first range R1. In this case, the shared object setting unit 225 cancels the setting of the shared object for the virtual object O2 in response to a change in the position of the virtual object O2, which has been set as the shared object, and in response to the virtual object O2 being the outside of the first range R1. Furthermore, in the virtual space V7, since the virtual object O3, which is a virtual object other than the virtual object O2, is located in the first range R1, and the user object UO2 is present within the second range R3 whose base point is the virtual object O3, the shared object setting unit 225 sets the virtual object O3 as a shared object. In this manner, the shared object setting unit 225 switches the shared object.

As described above, the shared object setting unit 225 switches the virtual object set as the shared object in response to a change in the positional relationship between the virtual object set as the shared object and the user objects UO1 and UO2. With this configuration, even when the positional relationship between the user U, another user U, and the virtual object set as the shared object changes, relative information about a new virtual object closest to the user U is transmitted from the user terminal 20 to the server 10 as position information of the user U. Therefore, even when the positional relationship between the user U, the other user U, and the shared object changes in the virtual space, the misalignment of the display position of the user U as viewed by the other user who is on the position information receiving side can be more effectively reduced.

Furthermore, when a plurality of virtual objects are located within the first range, and the same other user U is present within the second ranges whose base point is the respective virtual objects, the shared object setting unit 225 selects one virtual object from among the plurality of virtual objects and sets it as the shared object. At this time, the shared object setting unit 225 selects the virtual object that is closest to the user U. As a result, the relative information about the user U becomes information in which the virtual object closest to the user U serves as the base point, so that the misalignment of the display position of the user U can be further reduced compared to the case where relative information with respect to a virtual object located far away from the user U is used as the position information of the user U.

### Example 2 of Setting and Switching Shared Object

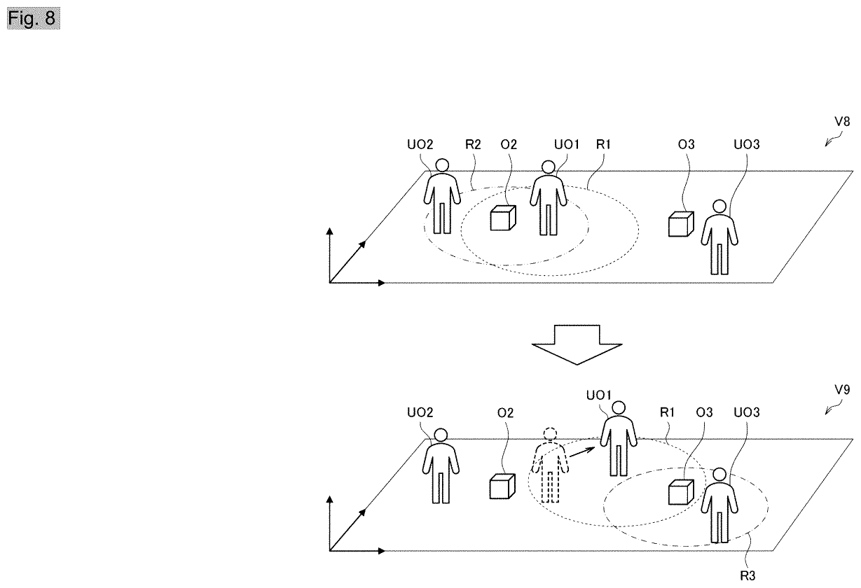

FIG. 8 is an explanatory diagram illustrating another example of the shared object setting unit 225 switching the shared object. A virtual space V8 in the upper part of FIG. 8 includes a user object UO1, a user object UO2, a user object UO3, a virtual object O2, and a virtual object O3.

In the example illustrated in FIG. 8, the virtual object O2 is located within a first range R1 whose base point is the user object UO1 in the virtual space V8. The user object UO2 is present within a second range R2 whose base point is the virtual object O2. On the other hand, the virtual object O3 is located outside the first range R1. In this case, the shared object setting unit 225 sets the virtual object O2 as a shared object for the user objects UO1 and UO2.

Next, assume that the state of the virtual space V8 is transitioned to the state of a virtual space V9 illustrated in the lower part of FIG. 8. As illustrated in FIG. 8, in the virtual space V9, the virtual object O2 is located outside the first range R1 due to a change in the position of the user object UO1. Furthermore, in the virtual space V9, the virtual object O3 is located within the first range R1. The user object UO3 is present within a second range R3 whose base point is the virtual object O3.

The shared object setting unit 225 cancels the setting of the shared object in response to a change in the position of the user object UO1 and in response to the position of the virtual object O2, which is set as the shared object, being the outside of the first range R1. Furthermore, as for the shared object setting unit 225, since the virtual object O3 is located within the first range R1 in the virtual space V9, and the user object UO3 is present within the second range R3 whose base point is the virtual object O3, the shared object setting unit 225 sets the virtual object O3 as a shared object.

### Example 3 of Setting and Switching Shared Object

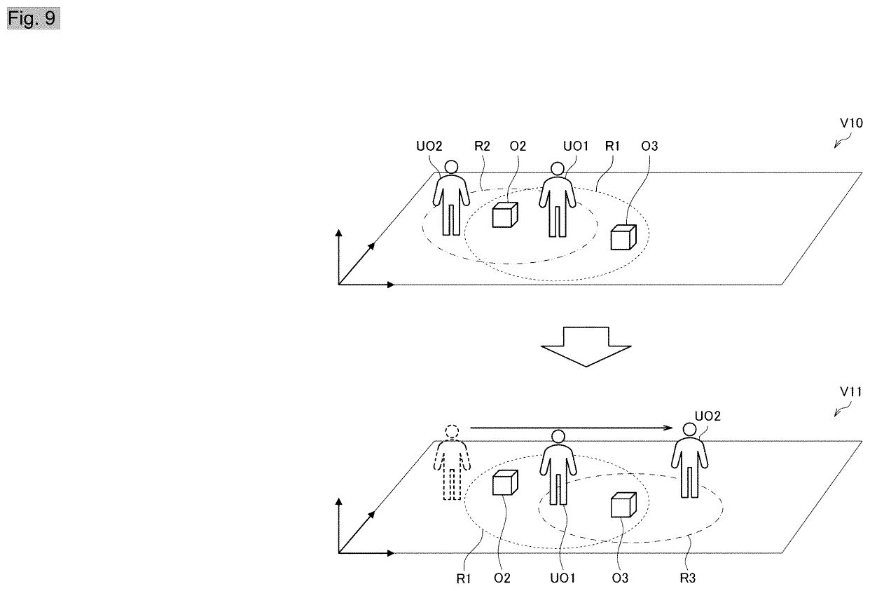

FIG. 9 is an explanatory diagram illustrating another example of the shared object setting unit 225 switching the shared object. A virtual space V10 in the upper part of FIG. 9 includes a user object UO1, a user object UO2, a virtual object O2, and a virtual object O3.

In the example illustrated in FIG. 9, it can be seen that in the virtual space V10, the virtual object O2 and the virtual object O3 are located within a first range R1 whose base point is the user object UO1. It can also be seen that the user object UO2 is present within a second range R2 whose base point is the virtual object O2. In this case, the shared object setting unit 225 sets the virtual object O2 as a shared object for the user objects UO1 and UO2.

Next, assume that the state of the virtual space V10 is transitioned to the state of a virtual space V11 illustrated in the lower part of FIG. 9. As illustrated in FIG. 9, it can be seen that the position of the user object UO2 has changed in the virtual space V11. Furthermore, it can be seen that the user object UO2 is now located within a second range R3 whose base point is the virtual object O3, due to a change in the position of the user object UO2.

Due to a change in the position of the user object UO2, the shared object setting unit 225 cancels the setting of the shared object of the virtual object O2 in response to the position of the user object UO2 being the outside of the second range R2 whose base point is the virtual object O2 set as the shared object. Furthermore, the shared object setting unit 225 newly sets, as the shared object, the virtual object O3 that is located in the virtual space V11 within the first range whose base point is the user object UO1, the user object UO2 being present within a second range R3 whose base point is the virtual object O3.

### Example 4 of Setting and Switching Shared Object

FIG. 10 is an explanatory diagram illustrating another example of the shared object setting unit 225 switching the shared object. A virtual space V12 in the upper part of FIG. 10 includes a user object UO1, a user object UO2, a virtual object O2, and a virtual object O3.

In the example illustrated in FIG. 10, the virtual object O2 is located within a first range R1 whose base point is the user object UO1 in the virtual space V12. It can also be seen that the user object UO2 is present within a second range R2 whose base point is the virtual object O2. In this case, the shared object setting unit 225 sets the virtual object O2 as a shared object for the user objects UO1 and UO2.

Next, assume that the state of the virtual space V12 is transitioned to the state of a virtual space V13. As illustrated in FIG. 10, the position of the user object UO1 has changed in the virtual space V13. Furthermore, due to a change in the position of the user object UO1, the virtual object O2 is located outside the first range R1. On the other hand, the virtual object O3 is located within the first range R1. The user object UO2 is located within a second range R3 whose base point is the virtual object O3.

The shared object setting unit 225 cancels the setting of the shared object for the virtual object O2 in response to a change in the position of the user object UO1 and in response to the position of the virtual object O2, which is set as the shared object, being the outside of the first range R1. Furthermore, the shared object setting unit 225 sets, as a shared object, the virtual object O3 that is located within the first range R1 whose base point is the user object UO1 in the virtual space V13, the user object UO2 being present within the second range R3 whose base point is the virtual object O3.

### Example 1 of Setting Shared Object for Each of Different Other Users

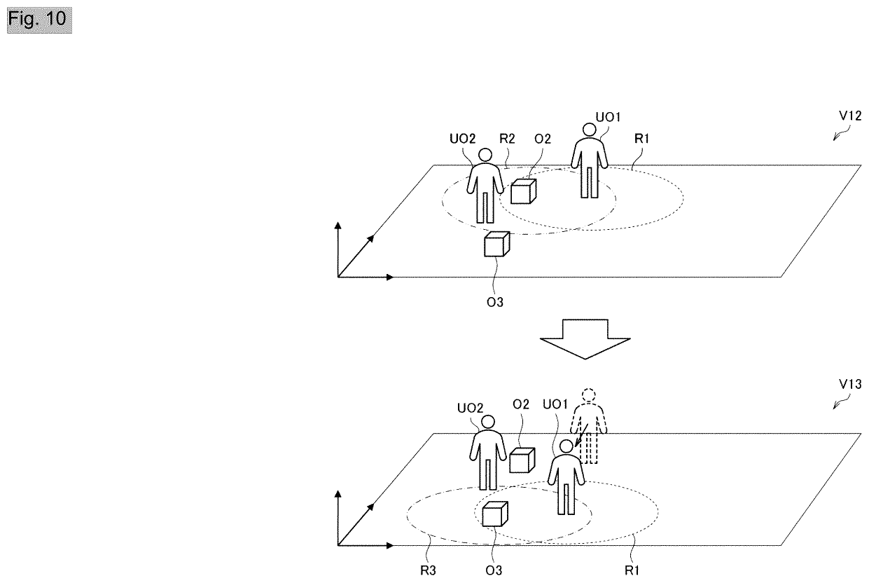

FIG. 11 is an explanatory diagram illustrating an example of the shared object setting unit 225 setting a shared object for each of different other users. A virtual space V14 illustrated in FIG. 11 includes a user object UO1, a user object UO2, a user object UO3, a virtual object O2, and a virtual object O4.

In the example illustrated in FIG. 11, in the virtual space V14, the virtual object O2 and the virtual object O4 are located within a first range R1 whose base point is the user object UO1. The user object UO2 is present within a second range R2 whose base point is the virtual object O2. The user object UO3 is present in a second range R3 whose base point is the virtual object O4.

In this case, the shared object setting unit 225 sets the virtual object O2 as a shared object for the user objects UO1 and UO2. The shared object setting unit 225 also sets the virtual object O4 as a shared object for the user objects UO1 and UO3.

In this way, the shared object setting unit 225 according to the present embodiment sets, for one or more virtual objects located in the first range R1 based on the user object UO1, each virtual object as a shared object to be shared among the user object UO1 and each of the other users. With this configuration, a shared object that serves as a reference for the relative position of the user object UO1 is set individually for each of the different users. Therefore, it is possible to reduce the misalignment of the display position of the user object UO1 as viewed by each of the other users.

### Example 2 of Setting Shared Object for Each of Different Other Users

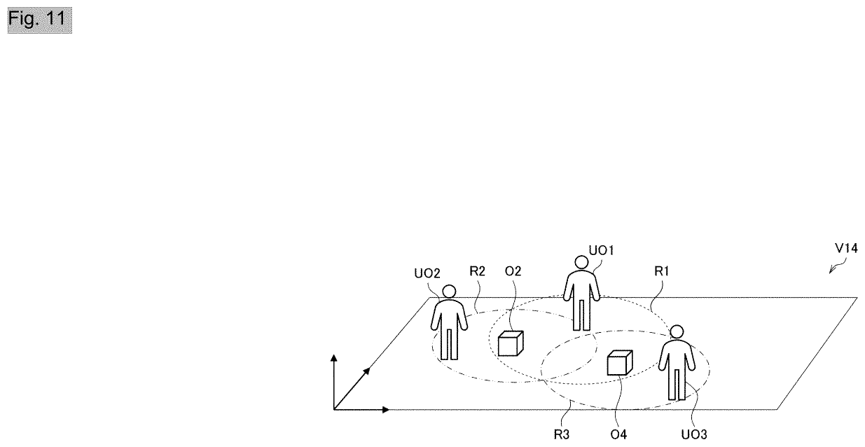

FIG. 12 is an explanatory diagram illustrating another example of the shared object setting unit 225 setting a shared object for each of different other users. A virtual space V15 illustrated in FIG. 12 includes a user object UO1, a user object UO2, a user object UO3, and a virtual object O2.

It can be seen that in the virtual space V15, the virtual object O2 is located within a first range R1 whose base point is the user object UO1. It can also be seen that the user object UO2 and the user object UO3 are located within a second range R2 whose base point is the virtual object O2.

In this case, the shared object setting unit 225 sets the virtual object O2 as a shared object for the user objects UO1 and UO2. The shared object setting unit 225 also sets the virtual object O2 as a shared object for the user objects UO1 and UO3. In this way, when a plurality of other users are present within the second range of a virtual object, the shared object setting unit 225 according to the present embodiment sets that virtual object as a shared object to be shared among the user object UO1 and the other users.

In this way, the shared object setting unit 225 according to the present embodiment can set the same virtual object as a shared object for a plurality of other users, or can set different virtual objects for the respective users, according to the positional relationship between the user U and each of the other users and the virtual object(s).

The details of the processing of the shared object setting unit 225 setting, canceling, and switching the shared object have been described above with reference to FIGS. 4 to 12.

Returning to FIG. 3, the functions of the control unit 220 of the user terminal 20 will be continuously described. The relative information calculation unit 227 has a function of, when the shared object is set by the shared object setting unit 225, calculating relative information indicating the relative positional relationship between that shared object and the user U. More specifically, the relative information calculation unit 227 uses the shared object as a base point, and calculates, as relative information, the coordinates of the user U with the shared object as an origin in the virtual space. The relative information also includes identification information of the virtual object set as the shared object.

If a shared object has been set by the shared object setting unit 225, the control unit 220 sets, as position information to be transmitted to the other user terminal(s) 20, relative information about the shared object serving as a base point. If a shared object has not been set by the shared object setting unit 225 or if the setting of the shared object has been canceled, the control unit 220 sets, as position information to be transmitted to the other user terminal(s) 20, the coordinates of the absolute position of the user U in the virtual space calculated by the coordinate calculation unit 223 or the relative position of the user U with respect to a specific virtual object set in advance as a reference. Alternatively, the control unit 220 sets, as position information to be transmitted to the other user terminal(s) 20, the relative position of the user U with respect to a specific virtual body in the virtual space.

The display control unit 229 performs display control of the display unit of the HMD 250. For example, the display control unit 229 has a function of controlling the generation and display of a first-person perspective image of the user U in the virtual space. At this time, the display control unit 229 displays user objects of the other users U at positions in the virtual space indicated by the position information of the other users U received from the other user terminals 20. The display device on which the image of the virtual space is displayed is not limited to the HMD 250, and may be another display device. For example, the display device may be a CRT display device, a liquid crystal display (LCD), or an OLED device, or may be a TV device, a projector, a smartphone, a tablet terminal, a PC, or the like.

### 3. Operation Example

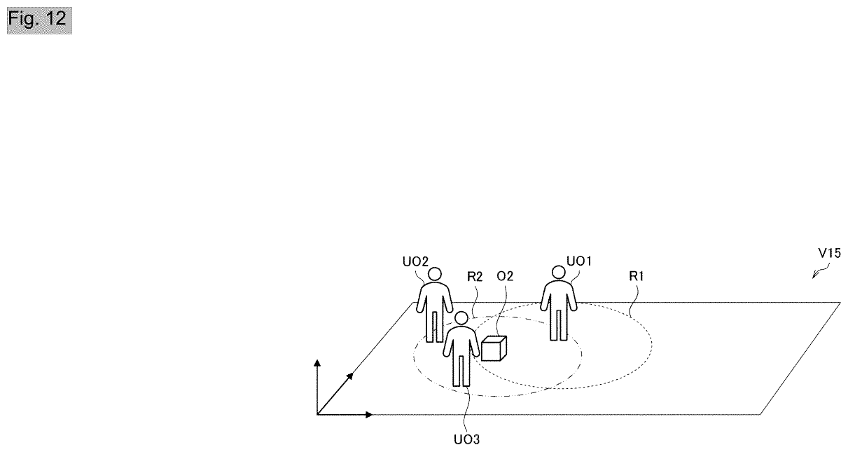

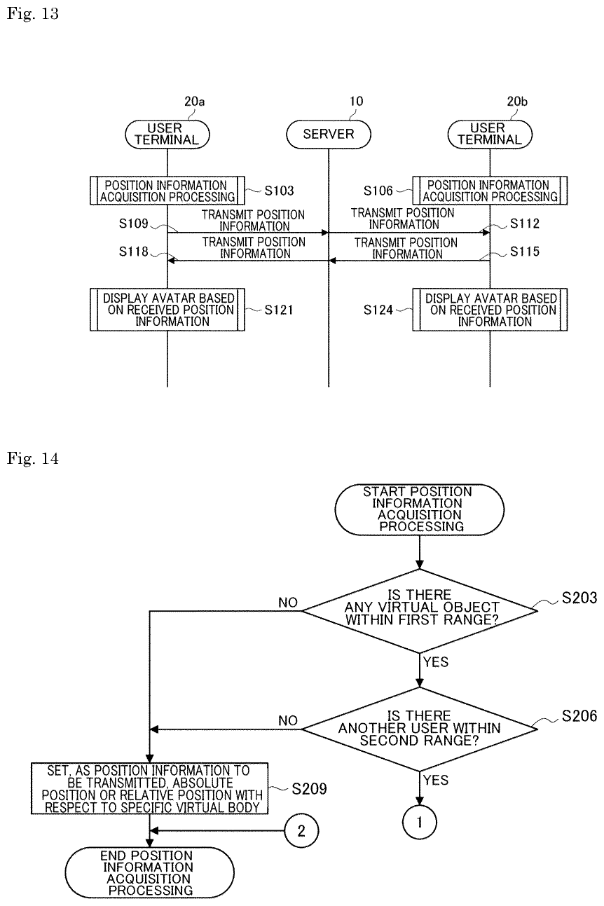

Subsequently, an example of an operation of the information processing system according to the present embodiment will be described with reference to FIGS. 13 to 16.

FIG. 13 is a sequence diagram illustrating the example of the operation of the information processing system according to the embodiment of the present disclosure. This information processing system repeats the series of operation processing illustrated in FIG. 13 at a predetermined update interval.

First, the user terminal 20a performs position information acquisition processing (S103). The position information acquisition processing performed by the user terminal 20 herein refers to processing of acquiring position information indicating the position in the virtual space of a user U wearing the HMD 250 connected to the user terminal 20.

Next, the user terminal 20b similarly performs the position information acquisition processing (S106). The processing of S103 and S106 may be performed separately at timings independent of each other. The user terminal 20a and the user terminal 20b may continue to perform the processing of S103 and S106, respectively.

Subsequently, the user terminal 20a transmits the acquired position information to the server 10 (S109). The server 10 transmits the position information received from the user terminal 20a to the user terminal 20b (S112). Similarly, the user terminal 20b transmits the acquired position information of the user U2 to the server 10 (S115). The server 10 transmits the position information of the user U2 received from the user terminal 20b to the user terminal 20a (S118).

Next, the user terminal 20a displays a user avatar (user object) representing the user U2 in the virtual space displayed on an HMD 250a based on the position information of the user U2 received from the server 10 (S121). Similarly, the user terminal 20b displays a user avatar of the user U1 in the virtual space displayed on an HMD 250b based on the position information of the user U1 received from the server 10 (S124).

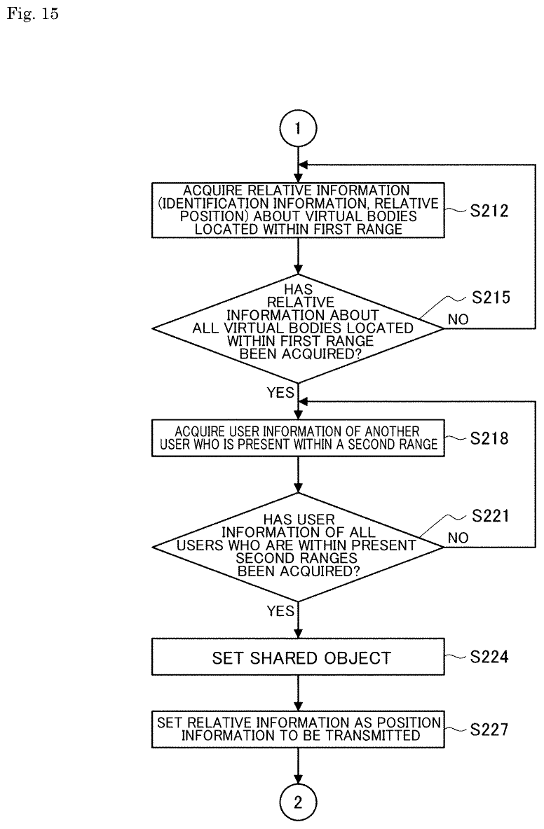

An example of the operation of the information processing system according to the present embodiment has been described above with reference to FIG. 13. By repeating the operation processing of the information processing system described with reference to FIG. 13, the position of each user in the virtual space can be updated in real time. Subsequently, a processing flow of the position information acquisition processing in S103 and S106 in the sequence diagram of FIG. 13 will be described with reference to FIG. 14 and FIG. 15.

FIG. 14 is a first flowchart illustrating an operation flow of the position information acquisition processing by the user terminal 20. First, the control unit 220 of the user terminal 20 determines whether or not there is any virtual object located within a first range whose base point is the position of the user U in the virtual space (S203). If there is no virtual object within the first range (S203/NO), the control unit 220 sets, as position information to be transmitted to the server 10, the coordinates of the absolute position of the user U, or the relative position of the user U with respect to a specific virtual body determined in advance as a reference (S209), and then ends the position information acquisition processing.

On the other hand, if there is any virtual object within the first range (S203/YES), the control unit 220 determines whether or not another user U is within any of second ranges whose base point is the respective virtual objects located within the first range (S206). If there is no other user within any of the second ranges (S206/NO), the processing proceeds to S209.

If there is another user within any of the second ranges (S206/YES), the processing proceeds to S212 in a flowchart illustrated in FIG. 15.

FIG. 15 is a second flowchart illustrating an operation flow of the position information acquisition processing by the user terminal 20. The relative information calculation unit 227 acquires relative information about virtual objects located within a first range whose base point is the user U (S212). The relative information includes identification information for uniquely identifying each virtual object, and a relative position indicating the relative positional relationship between each virtual object and the user U.

The relative information calculation unit 227 repeats the processing of S212 until the relative information about all virtual objects located within the first range is acquired (S215/NO). When the relative information calculation unit 227 acquires the relative information about all virtual objects located within the first range (S215/YES), the processing proceeds to S218.

Next, the control unit 220 acquires user information of another user U who is present within each of second ranges whose base point is all virtual objects located within the first range, respectively (S218). The user information is information for uniquely identifying each user. For example, the user information may be a user ID.

The control unit 220 repeats the processing of S218 until the user information of all other users U who are present within the second ranges is acquired (S221/NO). When the control unit 220 acquires the user information of all other users U who are within the second ranges (S221/YES), the processing proceeds to S224.

Next, the shared object setting unit 225 sets each of all virtual objects located within the first range for which relative information has been acquired in S215 as a shared object for the user U and another user U who is present within the second range whose base point is the corresponding virtual object (S224).

Next, the control unit 220 sets, as position information to be transmitted to each of the other users, each piece of relative information about the shared object serving as a base point for the user U and each of the other users (S227), and the processing returns to FIG. 14, where the position information acquisition processing ends.

An example of the operation of the position information acquisition processing performed by each of the user terminals 20 in S103 and S106 in FIG. 13 has been described above with reference to FIGS. 14 and 15.

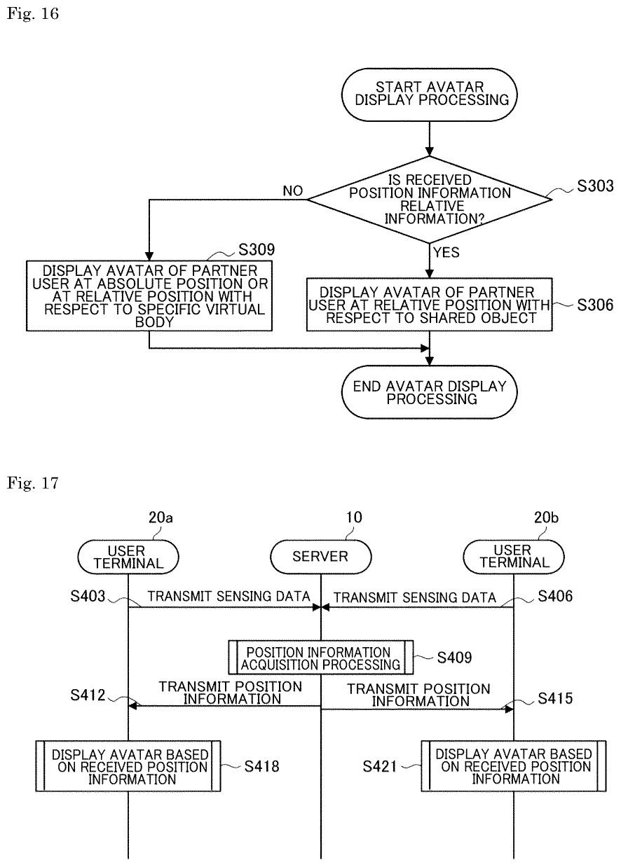

Next, an operation flow of avatar display based on the received position information in S121 and S124 illustrated in FIG. 13 will be described with reference to FIG. 16. FIG. 16 is a flowchart illustrating an example of an operation of processing of the user terminal 20 displaying avatars based on the received position information.

First, the communication unit 230 of the user terminal 20 receives position information of another user U (also referred to as a partner user) from the server 10. If the received position information is relative information about the other user U and a virtual object set as the shared object (S303/YES), the display control unit 229 of the user terminal 20 displays, based on the relative information, an avatar of the partner user at a relative position with respect to the shared object set on the other user U side (S306). The relative information includes identification information of a virtual object set as the shared object on the other user U side, and information on a relative position indicating a positional relationship of the other user U with respect to the shared object.

On the other hand, if the received position information is not relative information (S303/NO), specifically, if the received position information is an absolute position in the virtual space or a relative position with respect to a specific virtual body defined in advance as a reference, the display control unit 229 displays the avatar of the other user at the coordinates of the received absolute position of the other user U or at the relative position with respect to the specific virtual body (S309).

### 4. Modification Example

An example of the functional configuration and an example of the operation of the information processing system according to an embodiment of the present disclosure have been described above. In the above-described embodiment, the relative information calculation unit 227 of the user terminal 20 acquires, as relative position, the relative positional relationship between the position of the user object UO1 and the shared object. The present disclosure is not limited to this, and a relative positional relationship between the position of each part of the body of the user object UO1 and the shared object may be acquired as a relative position. When the shared object is a collection of small virtual objects, the relative information calculation unit 227 may acquire, as a relative position, a relative positional relationship between the position of each part of the body of the user object UO1 and at least one of the virtual objects that form the collection as the shared object. Such a modification example may be utilized, for example, in cases where VR or AR is used to perform remote training for medical surgery, assembly work, or the like. For example, the user terminal 20 may set, as a relative position, a relative positional relationship between a virtual object of an organ or a part of the body forming the shared object and the hand, fingers, or the like of the user object. According to such a modification example, it is possible to prevent a misalignment of the display position between a collection of small virtual objects, such as internal organs of the human body, and the user object.

In the above-described embodiment, when a plurality of virtual objects are located within a first range whose base point is the user U, and the same other user is present within second ranges whose base point is the respective virtual objects, the shared object setting unit 225 selects the virtual object closest to the user object UO1 from among the a plurality of virtual objects and sets it as the shared object. The present disclosure is not limited to this, and the shared object setting unit 225 may select a virtual object to be set as a shared object in accordance with a priority level that is preset for each of the plurality of virtual objects. For example, in an example where the present disclosure is applied to a situation in which training for remote surgery on human body,

the shared object setting unit 225 may set the priority of a virtual object representing a specific organ that is the subject of the surgery to the highest level among the virtual objects representing human body organs, and may set the priority of virtual objects of organs other than the specific organ to a low level. According to such a modification example, the shared object setting unit 225 can set the shared object in accordance with the priority to more effectively avoid the misalignment of the display position with respect to the user object.

In the above-described embodiment, the display control unit 229 of the user terminal 20 performs processing of displaying an avatar (user object) representing another user U (partner user) based on the position information of the other user U (partner user) received from the server 10. At this time, the user terminal 20 may further perform the following processing. The display control unit 229 of the user terminal 20 detects, based on the identification information of the shared object included in the received position information of another user U, whether the shared object for the user U and the other user U has been switched. When the display control unit 229 detects that the shared object has been switched, the display control unit 229 calculates a distance to the display position of the other user U that is calculated based on each of the shared objects before and after the switching. If the calculated distance is equal to or greater than a threshold value, the display control unit 229 performs display control to draw the avatar of the other user U moving at a predetermined speed from the display position before the switching to the display position after the switching. According to such a modification example, even when the display position of the other user U changes significantly before and after switching the shared object, it is possible to prevent the other user U from appearing to move suddenly, which creates discomfort.

In the above-described embodiment, the control unit 220 of the user terminal 20 has the functions of the coordinate calculation unit 223, the shared object setting unit 225, the relative information calculation unit 227, and the display control unit 229. The present disclosure is not limited to this, and the control unit 120 of the server 10 may have the functions of the coordinate calculation unit 223, the shared object setting unit 225, the relative information calculation unit 227, and the display control unit 229, and the control unit 120 of the server 10 may perform the processing of acquiring the position information of the user U, setting, canceling, and switching the shared object, and display control. A specific description will be given below with reference to FIG. 17.

FIG. 17 is a sequence diagram illustrating an example of operation processing of the information processing system when the server 10 performs position information acquisition processing, shared object setting processing, and display control processing. First, the user terminal 20a and the user terminal 20b transmit the acquired sensing data of the user U1 and the user U2, respectively, to the server 10 (S403, S406).

Next, the server 10 performs the position information acquisition processing based on the received sensing data of each user U (S409). In S409, the server 10 performs the same processing as those in S103 and S106 described with reference to the sequence diagram of FIG. 13.

The server 10 transmits the acquired position information to each user terminal 20 (S412, S415). Specifically, the server 10 transmits, to the user terminal 20b, the position information of the user U1 acquired based on the sensing data of the user terminal 20a. The server 10 also transmits, to the user terminal 20a, the position information of the user U2 acquired based on the sensing data of the user terminal 20b. Next, the user terminal 20a displays an avatar of the user U2 based on the received position information of the user U2 (S418). The user terminal 20b displays an avatar of the user U1 based on the received position information of the user U1 (S421).

An example of the operation processing in which the server 10 performs the position information acquisition processing, the shared object setting processing, and the display control processing has been described above with reference to FIG. 17.

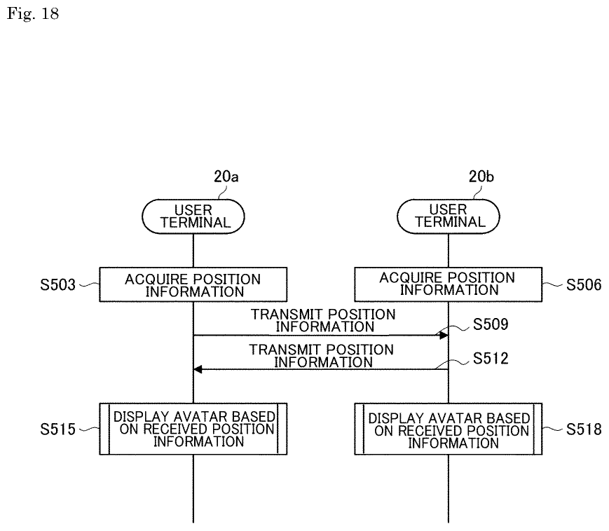

Furthermore, as another modification example of the information processing system according to the present disclosure, user terminals 20 can communicate directly with each other and transmit and receive the position information of each user U without going through the server 10. FIG. 18 is a sequence diagram illustrating an example of operation processing of the information processing system when user terminals 20 communicate directly with each other.

First, the user terminal 20a and the user terminal 20b perform the position information acquiring processing for the user U1 and the user U2, respectively (S503, S506).

Next, the user terminal 20a transmits the acquired position information of the user U1 to the user terminal 20b (S509). Similarly, the user terminal 20b transmits the acquired position information of the user U2 to the user terminal 20a (S512).

The user terminal 20a and the user terminal 20b each display an avatar of the user U1 or the user U2 based on the received position information (S515, S518).

### 5. Hardware Configuration Example

The embodiments of the present disclosure have been described above. The above-described information processing, such as setting, canceling, and switching of the shared object, and calculation of relative information about the shared object serving as a base point, is implemented by cooperation between software and hardware. A hardware configuration example that can be applied to the server 10 and the user terminal 20 will be described below.

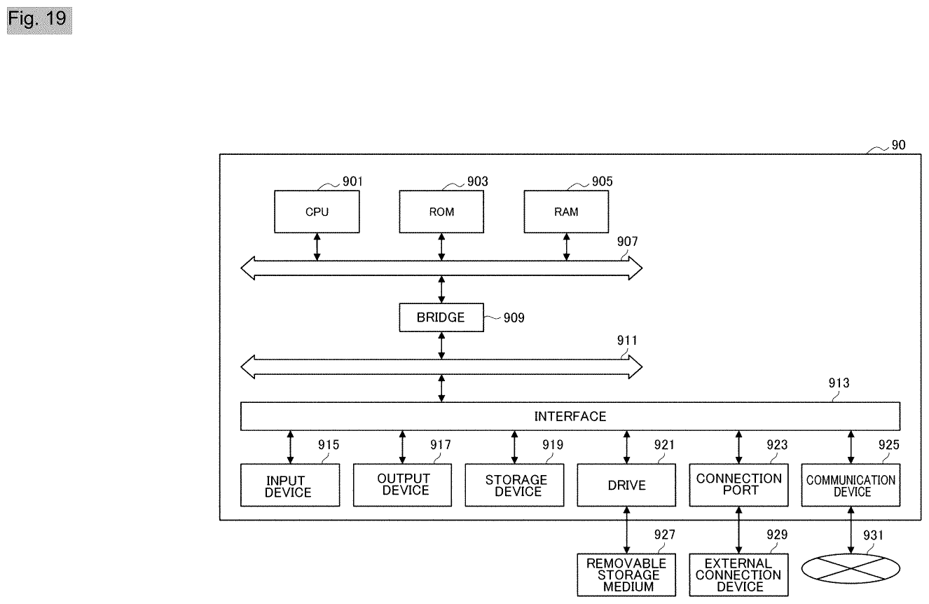

FIG. 19 is a block diagram illustrating an example of a hardware configuration 90. The hardware configuration example of the hardware configuration 90 described below is merely one example of the hardware configuration of the server 10 and the user terminal 20. Therefore, each of the server 10 and the user terminal 20 does not necessarily have to include all hardware components illustrated in FIG. 19. Some of the hardware components illustrated in FIG. 19 may not be present in the server 10 and the user terminal 20.

As illustrated in FIG. 19, the hardware configuration 90 includes a CPU 901, a read only memory (ROM) 903, and a RAM 905. The hardware configuration 90 may also include a host bus 907, a bridge 909, an external bus 911, an interface 913, an input device 915, an output device 917, a storage device 919, a drive 921, a connection port 923, and a communication device 925. The hardware configuration 90 may have a processing circuit such as one called a graphics processing unit (GPU), a digital signal processor (DSP), or an application specific integrated circuit (ASIC) instead of or in addition to the CPU 901.

The CPU 901 functions as an arithmetic processing device and a control device, and controls all or part of an operation in the hardware configuration 90 according to various programs recorded in the ROM 903, the RAM 905, the storage device 919, or a removable recording medium 927. The ROM 903 stores programs and calculation parameters used by the CPU 901. The RAM 905 temporarily stores programs used in the execution of the CPU 901, parameters that change appropriately during the execution, or/and the like. The CPU 901, the ROM 903, and the RAM 905 are interconnected by the host bus 907 configured of an internal bus such as a CPU bus. Further, the host bus 907 is connected to the external bus 911 such as a peripheral component interconnect/interface (PCI) bus via the bridge 909.

The input device 915 is, for example, a device operated by the user, such as a button. The input device 915 may include a mouse, a keyboard, a touch panel, switches, levers, and the like. Further, the input device 915 may also include a microphone that detects a voice of the user. The input device 915 may be, for example, a remote control device using infrared rays or other radio waves, or may be an external connection device 929 such as a mobile phone corresponding to an operation of the hardware configuration 90. The input device 915 includes an input control circuit that generates an input signal based on information input by the user and outputs the input signal to the CPU 901. The user inputs various types of data to the hardware configuration 90 and instructs processing operations through an operation on the input device 915.

The input device 915 may also include an imaging device and a sensor. The imaging device is a device that captures an image of a real space using an imaging element such as a charge coupled device (CCD) or a complementary metal oxide semiconductor (CMOS), and various types of members such as a lens for controlling the formation of a subject image on the imaging element, and generates a captured image. The imaging device may be one that captures a still image or one that captures a moving image.

The sensor may include various types of sensors such as, for example, a distance measurement sensor, an acceleration sensor, a gyro sensor, a geomagnetic sensor, a vibration sensor, a light sensor, and a sound sensor. The sensor acquires information about the state of the hardware configuration 90 itself, such as the attitude of the housing of the hardware configuration 90, or information about the surrounding environment of the hardware configuration 90, such as the brightness or noise around the hardware configuration 90. The sensor may also include a global positioning system (GPS) sensor that receives a GPS signal to measure the latitude, longitude, and altitude of the device.

The output device 917 is configured of a device capable of visually or audibly notifying the user of acquired information. The output device 917 can be, for example, a display device such as a liquid crystal display (LCD) or an organic electro-luminescence (EL) display, or a sound output device such as a speaker or a headphone. Further, the output device 917 may include a plasma display panel (PDP), a projector, a hologram, a printer device, and the like. The output device 917 outputs a result obtained by processing of the hardware configuration 90 as text or a video such as an image, or as a sound such as voice or acoustic sound. The output device 917 may also include a lighting device for brightening surroundings, and the like.

The storage device 919 is a data storage device configured as an example of the storage unit of the hardware configuration 90. The storage device 919 is configured of, for example, a magnetic storage device such as a hard disk drive (HDD), a semiconductor storage device, an optical storage device, or a magneto-optical storage device. The storage device 919 stores programs to be executed by the CPU 901, various types of data, various types of data acquired from the outside, and the like.

The drive 921 is a reader and writer for the removable recording medium 927 such as a magnetic disk, an optical disc, a magneto-optical disc, or a semiconductor memory, and is built in or externally attached to the hardware configuration 90. The drive 921 reads information recorded on the attached removable recording medium 927 and outputs the information to the RAM 905. The drive 921 also writes records to the attached removable recording medium 927.

The connection port 923 is a port for directly connecting a device to the hardware configuration 90. The connection port 923 can be, for example, a universal serial bus (USB) port, an IEEE1394 port, or a small computer system interface (SCSI) port. The connection port 923 may also be an RS-232C port, an optical audio terminal, an HDMI (registered trademark) (High-Definition Multimedia Interface) port, or the like. A connection of the external connection device 929 to the connection port 923 makes it possible for various types of data to be exchanged between the hardware configuration 90 and the external connection device 929.

The communication device 925 is, for example, a communication interface configured of a communication device for connection to a local network, or a communication network with a base station for wireless communication, or the like. The communication device 925 may be, for example, a communication card for a wired or wireless local area network (LAN), Bluetooth (registered trademark), Wi-Fi (registered trademark), or a wireless USB (WUSB). The communication device 925 may also be a router for optical communication, a router for asymmetric digital subscriber line (ADSL), or any modem for communication. The communication device 925, for example, transmits or receives signals or the like to or from the Internet or another communication device using a predetermined protocol such as TCP/IP. The local network or the communication network with a base station, which is connected to the communication device 925, is a wired or wireless network, such as the Internet, home LAN, infrared communication, radio wave communication, or satellite communication.

### 6. Supplements

Although the preferred embodiments of the present disclosure have been described in detail with reference to the accompanying figures as described above, the technical scope of the present disclosure is not limited to such examples. It is apparent that those having ordinary knowledge in the technical field of the present disclosure could conceive various modified examples or changed examples within the scope of the technical ideas set forth in the claims, and it should be understood that these also naturally fall within the technical scope of the present disclosure.

For example, in the above-described embodiment, the user terminal 20 acquires the position information of the user U based on the sensing data acquired by the camera 240, the camera 241, the camera 240, and the HMD 250. This type of method is generally referred to as an outside-in method as a method for tracking the position of a user U wearing an HMD. However, the information processing system according to the present disclosure is not limited to this example. For example, as another example of the outside-in method, instead of the cameras 240, 241, and 242, a base station that radially emits laser light may be installed. The user terminal 20 may acquire the position information of the user U wearing the HMD 250 from the reception time of the laser light received by the HMD 250, the angle of the laser at the reception point, and the time difference between the time the laser was emitted and the time the laser was received. Alternatively, as another example, the user terminal 20 may acquire the position information of the user U by a method using a geomagnetic sensor instead of the cameras 240, 241, and 242.

Furthermore, the user terminal 20 may acquire the position information of the user U by an inside-out method, which is a method of tracking the position of the HMD 250 based on a surrounding image acquired by a camera equipped in the HMD 250 itself. For example, the user terminal 20 may acquire the position information of the user U by simultaneous localization and mapping (SLAM), which creates an environmental map of the surrounding situation of the user U using a camera equipped in the HMD 250 and estimates the self-position of the HMD 250 worn by the user U.

The steps in the processing of the operations of the server 10 and the user terminal 20, according to the present embodiment, do not necessarily need to be processed in chronological order according to the order described in the explanatory diagram. For example, each step in the processing of the operations of the server 10 and the user terminal 20 may be processed in an order different from the order described in the explanatory diagram, or may be processed in parallel.

It is also possible to create one or more computer programs for causing hardware such as a CPU, ROM, and RAM built into the server 10 and the user terminal 20 described above to implement the functions of the information processing system according to the present embodiment. Further, a computer-readable storage medium having the one or more computer programs stored therein is provided.

Further, the effects described herein are merely explanatory or exemplary and are not intended as limiting. In other words, the technology according to the present disclosure may exhibit other effects apparent to those skilled in the art from the description herein, in addition to or in place of the above effects.

The following configurations also fall within the technical scope of the present disclosure.
(1)

An information processing device including a control unit that:

sets, as a shared object for a first user and a second user, a virtual object located within a first range whose base point is the first user in a virtual space, with the second user being present within a second range whose base point is the virtual object;

transmits relative information indicating a relative positional relationship between the shared object and the first user to a user terminal associated with the second user; and

switches the setting of the shared object in response to a change in at least any of a position of the first user, a position of the shared object, and a position of the second user in the virtual space.
(2)

The information processing device according to (1), wherein the control unit switches the setting of the shared object by canceling the setting of the shared object for the virtual object and setting a new virtual object as the shared object.
(3)

The information processing device according to (2), wherein

the control unit

cancels the setting of the shared object in response to a change in a position of the first user in the virtual space and in response to a position of the shared object being outside of the first range; and

sets, as the shared object, a new virtual object located within the first range whose base point is the changed position, with another user being present within a second range whose base point is the new virtual object.
(4)

The information processing device according to (2), wherein

the control unit

cancels the setting of the shared object in response to a change in a position of the shared object in the virtual space and in response to a position of the shared object being outside of the first range; and

sets, as the shared object, a new virtual object located within a first range whose base point is the first user, with another user being present within a second range whose base point is the new virtual object.
(5)

The information processing device according to (2), wherein

the control unit

cancels the setting of the shared object in response to a position of the second user being outside of the second range whose base point is the shared object due to a change in the position of the second user in the virtual space; and

sets, as the shared object, a new virtual object located within a first range whose base point is the first user, with another user being present within a second range whose base point is the new virtual object.
(6)

The information processing device according to any one of (3) to (5), wherein the control unit transmits relative information indicating a relative positional relationship between the newly set shared object and the first user to a user terminal associated with the other user.
(7)

The information processing device according to (1) or (2), wherein when no virtual object located within a first range whose base point is the first user is detected, or when the second user being present within a second range whose base point is the shared object is not detected, the control unit cancels the setting of the virtual object that has been set as the shared object.
(8)

The information processing device according to (6), wherein when no virtual object is located within the first range, the control unit transmits, to the user terminal associated with the second user, coordinate information indicating a position of the first user in the virtual space or relative information indicating a positional relationship between the first user and a preset virtual object.
(9)

The information processing device according to any one of (1) to (8), wherein when a plurality of virtual objects are located within the first range whose base point is the first user, and the second user is present within the second range whose base point is each of the plurality of virtual objects,

the control unit selects one virtual object from among the plurality of virtual objects and sets the one virtual object as the shared object.
(10)

The information processing device according to (8), wherein the control unit selects a virtual object located closest to the first user in the virtual space from among the plurality of virtual objects.
(11)

The information processing device according to (8), wherein the control unit selects a virtual object to be set as the shared object from among the plurality of virtual objects in accordance with a priority that is preset for each of the plurality of virtual objects.
(12)

The information processing device according to any one of (1) to (11), wherein for one or more virtual objects located within the first range whose base point is the first user, when another user is present within each second range whose base point is each of the one or more virtual objects, the control unit

sets each of the one or more virtual objects as the shared object to be shared between the first user and each other user; and

transmits relative information indicating a relative positional relationship between each of the set shared objects and the first user to each user terminal associated with each other user.
(13)

The information processing device according to any one of (1) to (12), wherein when a plurality of other users are present within the second range, the control unit sets the virtual object as the shared object to be shared between the first user and each of the other users; and

transmits relative information indicating a relative positional relationship between the first user and the shared object to each user terminal associated with each of the other users.
(14)

The information processing device according to (13), wherein the control unit calculates, as the relative information, a relative positional relationship between a position of each part of a body of the first user included in a first user object representing the first user in the virtual space, and the shared object,
(15)

The information processing device according to any one of (1) to (14), wherein when receiving, from a user terminal associated with the second user, identification information of a shared object set with the second user serving as a base point and relative information indicating a relative positional relationship of the second user with respect to the shared object, as position information of the second user, the control unit performs control to display a second user object representing the second user at a position in the virtual space calculated based on the relative information.
(16)

The information processing device according to (15), wherein

the relative information includes identification information for enabling to uniquely identify a virtual object set as the shared object, and

when detecting that a shared object set with the second user serving as a base point has been switched over based on identification information of the shared object received from a user terminal associated with the second user, the control unit

calculates a distance between display positions of the second user that are calculated based on each of the shared objects before and after the switching; and

when the calculated distance is equal to or greater than a threshold value, performs control to draw an action of the second user object moving at a predetermined speed from a display position before the switching to a display position after the switching.
(17)

The information processing device according to any one of (1) to (16), further including a communication unit that receives, from a user terminal associated with the first user and a user terminal associated with the second user, position information of each user.
(18)

The information processing device according to any one of (1) to (16), further including a communication unit that communicates with a user terminal associated with the second user or a server,

wherein the control unit

displays, on a display unit, the virtual space and the virtual object that are within a field of view of the first user in the virtual space;

transmits, from the communication unit, the relative information indicating the relative positional relationship between the shared object and the first user in the virtual space; and

displays a user object representing the second user on the basis of relative information received from the user terminal or the server, the relative information indicating a relative positional relationship between a shared object set with the second user serving as a base point and the second user.
(19)

A program causing a computer to function as a control unit that:

sets, as a shared object for a first user and a second user, a virtual object located within a first range whose base point is the first user in a virtual space, with the second user being present within a second range whose base point is the virtual object;

transmits relative information indicating a relative positional relationship between the shared object and the first user to a user terminal associated with the second user; and

switches setting of the shared object in response to a change in at least any of a position of the first user, a position of a virtual object set as the shared object, and a position of the second user in the virtual space.
(20)

An information processing system including:

a first user terminal associated with a first user;

a second user terminal associated with a second user; and

an information processing device including a control unit that:

sets, as a shared object for the first user and the second user, a virtual object located within a first range whose base point is the first user in a virtual space, with the second user being present within a second range whose base point is the virtual object;

transmits relative information indicating a relative positional relationship between the shared object and the first user to the second user terminal; and

switches setting of the shared object in response to a change in at least any of a position of the first user, a position of a virtual object set as the shared object, and a position of the second user in the virtual space,

wherein

the second user terminal displays a user object representing the first user at a position in a virtual space calculated based on the relative information received from the information processing device.

### REFERENCE SIGNS LIST

10 Server
110 Storage unit
120 Control unit
130 Communication unit
20 User terminal
210 Storage unit
220 Control unit
221 Sensor data acquisition unit
223 Coordinate calculation unit
225 Shared object setting unit
227 Relative information calculation unit
229 Display control unit
230 Communication unit
240 Camera
241 Camera
242 Camera
250 HMD

1. An information processing device comprising a control unit that:
sets, as a shared object for a first user and a second user, a virtual object located within a first range whose base point is the first user in a virtual space, with the second user being present within a second range whose base point is the virtual object;
transmits relative information indicating a relative positional relationship between the shared object and the first user to a user terminal associated with the second user; and
switches the setting of the shared object in response to a change in at least any of a position of the first user, a position of the shared object, and a position of the second user in the virtual space.

2. The information processing device according to claim 1, wherein the control unit switches the setting of the shared object by canceling the setting of the shared object for the virtual object and setting a new virtual object as the shared object.

3. The information processing device according to claim 2, wherein the control unit cancels the setting of the shared object in response to a change in a position of the first user in the virtual space and in response to a position of the shared object being outside of the first range; and
sets, as the shared object, a new virtual object located within the first range whose base point is the changed position, with another user being present within a second range whose base point is the new virtual object.

4. The information processing device according to claim 2, wherein the control unit cancels the setting of the shared object in response to a change in a position of the shared object in the virtual space and in response to a position of the shared object being outside of the first range; and
sets, as the shared object, a new virtual object located within a first range whose base point is the first user, with another user being present within a second range whose base point is the new virtual object.

5. The information processing device according to claim 2, wherein the control unit cancels the setting of the shared object in response to a position of the second user being outside of the second range whose base point is the shared object due to a change in the position of the second user in the virtual space; and
sets, as the shared object, a new virtual object located within a first range whose base point is the first user, with another user being present within a second range whose base point is the new virtual object.

6. The information processing device according to claim 3, wherein the control unit transmits relative information indicating a relative positional relationship between the newly set shared object and the first user to a user terminal associated with the other user.

7. The information processing device according to claim 1, wherein when no virtual object located within a first range whose base point is the first user is detected, or when the second user being present within a second range whose base point is the shared object is not detected, the control unit cancels the setting of the virtual object that has been set as the shared object.

8. The information processing device according to claim 6, wherein when no virtual object is located within the first range, the control unit transmits, to the user terminal associated with the second user, coordinate information indicating a position of the first user in the virtual space or relative information indicating a positional relationship between the first user and a preset virtual object.

9. The information processing device according to claim 1, wherein when a plurality of virtual objects are located within the first range whose base point is the first user, and the second user is present within the second range whose base point is each of the plurality of virtual objects,
the control unit selects one virtual object from among the plurality of virtual objects and sets the one virtual object as the shared object.

10. The information processing device according to claim 9, wherein the control unit selects a virtual object located closest to the first user in the virtual space from among the plurality of virtual objects.

11. The information processing device according to claim 9, wherein the control unit selects a virtual object to be set as the shared object from among the plurality of virtual objects in accordance with a priority that is preset for each of the plurality of virtual objects.

12. The information processing device according to claim 1, wherein
for one or more virtual objects located within the first range whose base point is the first user, when another user is present within each second range whose base point is each of the one or more virtual objects, the control unit
sets each of the one or more virtual objects as the shared object to be shared between the first user and each other user; and
transmits relative information indicating a relative positional relationship between each of the set shared objects and the first user to each user terminal associated with each other user.

13. The information processing device according to claim 1, wherein
when a plurality of other users are present within the second range, the control unit sets the virtual object as the shared object to be shared between the first user and each of the other users; and
transmits relative information indicating a relative positional relationship between the first user and the shared object to each user terminal associated with each of the other users.

14. The information processing device according to claim 13, wherein the control unit calculates, as the relative information, a relative positional relationship between a position of each part of a body of the first user included in a first user object representing the first user in the virtual space, and the shared object,

15. The information processing device according to claim 1, wherein when receiving, from a user terminal associated with the second user, identification information of a shared object set with the second user serving as a base point and relative information indicating a relative positional relationship of the second user with respect to the shared object, as position information of the second user, the control unit performs control to display a second user object representing the second user at a position in the virtual space calculated based on the relative information.

16. The information processing device according to claim 15, wherein
the relative information includes identification information for enabling to uniquely identify a virtual object set as the shared object, and
when detecting that a shared object set with the second user serving as a base point has been switched over based on identification information of the shared object received from a user terminal associated with the second user,
the control unit
calculates a distance between display positions of the second user that are calculated based on each of the shared objects before and after the switching; and
when the calculated distance is equal to or greater than a threshold value, performs control to draw an action of the second user object moving at a predetermined speed from a display position before the switching to a display position after the switching.

17. The information processing device according to claim 1, further comprising a communication unit that receives, from a user terminal associated with the first user and a user terminal associated with the second user, position information of each user.

18. The information processing device according to claim 1, further comprising a communication unit that communicates with a user terminal associated with the second user or a server,
wherein the control unit
displays, on a display unit, the virtual space and the virtual object that are within a field of view of the first user in the virtual space;
transmits, from the communication unit, the relative information indicating the relative positional relationship between the shared object and the first user in the virtual space; and
displays a user object representing the second user on the basis of relative information received from the user terminal or the server, the relative information indicating a relative positional relationship between a shared object set with the second user serving as a base point and the second user.

19. A program causing a computer to function as:
a control unit that:
sets, as a shared object for a first user and a second user, a virtual object located within a first range whose base point is the first user in a virtual space, with the second user being present within a second range whose base point is the virtual object;
transmits relative information indicating a relative positional relationship between the shared object and the first user to a user terminal associated with the second user; and
switches setting of the shared object in response to a change in at least any of a position of the first user, a position of a virtual object set as the shared object, and a position of the second user in the virtual space.

20. An information processing system comprising:
a first user terminal associated with a first user;
a second user terminal associated with a second user; and
an information processing device including a control unit that:
sets, as a shared object for the first user and the second user, a virtual object located within a first range whose base point is the first user in a virtual space, with the second user being present within a second range whose base point is the virtual object;
transmits relative information indicating a relative positional relationship between the shared object and the first user to the second user terminal; and
switches setting of the shared object in response to a change in at least any of a position of the first user, a position of a virtual object set as the shared object, and a position of the second user in the virtual space,
wherein
the second user terminal displays a user object representing the first user at a position in a virtual space calculated based on the relative information received from the information processing device.
